(19) United States
(12) Patent Application Publication
(10) Pub. No.: US 2007/0030833 A1
(43) Pub. Date: Feb. 8, 2007

(54) Method for managing network content delivery using client application workload patterns and related systems

(76) Inventors: Fahd B. Pirzada, Austin, TX (US); Deepak Janakiraman, Austin, TX (US); Liam B. Quinn, Austin, TX (US)

Correspondence Address: Brian W. Peterman;O'KEEFE, EGAN & PETERMAN, LLP, Building C, Suite 200, 1101 Capital of Texas Highway South, Austin, TX, 78746, US

(21) Appl. No.: 11/195,557

(22) Filed: Aug. 2, 2005

(51) Int. Cl. H01J 9/36; H04Q 7/24

(52) U.S. Cl. 370/338; 445/69

(57) ABSTRACT

Methods and systems are disclosed for managing network content delivery using client application workload patterns. In addition to network link analysis done by prior systems, application level performance of the end user device is analyzed in order to adjust parameters of the delivered content data stream and to thereby improve the quality of service (QoS) for delivered content.

### TECHNICAL FIELD OF THE INVENTION

This invention relates to the techniques for managing network bandwidth and content delivery in networked systems, particularly in systems where network content is delivered to end user devices in a home environment or a small or medium business environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Networks are often utilized to connect together a variety of information handling systems. Networks can utilize a wide variety of communication protocols and take a wide variety of forms including wired or wireless network connections and combinations thereof. Digital content is often distributed through such networks from content servers to systems at which the content is viewed. The quality of the end user experience in viewing this content depends greatly upon the management of the network environment for delivering the content. In addition, a wide variety of content delivery environments exist including content delivery in a digital home environment or a small or medium business environment.

In the digital home environment, the need for multimedia content delivery is giving rise to new networking and computing scenarios and network load balancing requirements. The digital home will increasingly encompass a range of digital devices, with streaming of multimedia content to multiple wireless devices a key basis for success. These devices will have varied processing and display capabilities. One significant challenge is load balancing and prioritization between wireless quality of service (QoS) and processing overhead on these end user devices. In the typical usage scenario, the broadband Internet connection to the home is terminated on standalone router platforms with extensions to a powerful media center personal computer (PC) typically using a wireless network. The wireless network maintains links to a host of devices ranging from laptops and PDAs (personal digital assistants) to VoIP phones (voice over Internet protocol telephones) and MP3 players. The media center PC encodes the incoming media streams for relay on the wireless link, and the network devices decode these streams for end-user consumption.

One significant problem, however, is that these wireless network devices often are limited in processing power due to mobility and battery life constraints. Therefore, decoding the multimedia content can incur a serious overhead on the processing capabilities of the end device. For example, a P4 (INTEL PENTIUM 4 processor) laptop can decode a highly compressed stream in software. However, if the laptop is being used for a 3D application, software decoding by the laptop processor can lead to a processing bottleneck with respect to delivering the 3D content with an adequate QoS. This processing bottleneck presents a difficult content delivery problem.

Prior solutions for managing networks have often focused on managing the network link between devices and the usage of network bandwidth. In addition, these network bandwidth management solutions have modified network data compression to save and improve the usage of network bandwidth. For example, link adaptation in 3G cellular technologies have encoding and modulation schemes based on the link performance. The wireless INTEL SPEEDSTEP power manager defines power states and then maps them to power modes of the processor and network processor. This SPEEDSTEP manager defines the application to be in one of four power states: running, waiting, memory bound or memory-and-CPU bound. With respect to processing capabilities, solutions have proposed sharing processing capabilities among thin clients. Similarly, other solutions have addressed application workload management within a single system or among a number of server systems with respect to sharing processing workloads. These prior efforts, however, do not provide an adequate solution to the problem of content delivery for devices with potentially limited processing capabilities. In addition, these prior efforts are not well suited for home environments or small and medium business environments where network bandwidth may not be a significant constraint but processing power for end-user devices is a significant constraint with respect to QoS of the delivered content.

### SUMMARY OF THE INVENTION

The present invention provides systems and methods for managing network content delivery using client application workload patterns. As described herein, in addition to network link analysis done by prior systems, the present invention also includes an analysis of application level performance of the end user device in order to adjust parameters of the delivered content data stream and to thereby improve the quality of service (QoS) for delivered content.

In one embodiment, the present invention is a method for managing network content delivery including communicating a content data stream through a network to a device, determining at the device at least one parameter related to a performance level for an application operating on the device to deliver the content to a user, and adjusting the content data stream to thereby adjust an amount of processing required by the device depending upon the parameter. In addition, the communicating step can include communicating a plurality of content data streams through the wireless network to a plurality of devices. The determining step can include determining at each device at least one parameter related to a performance level for an application operating on that device to deliver content to a user. And the adjusting step can include adjusting the content data stream for each device to thereby adjust an amount of processing required by the device depending upon the application level parameter for that device. Further, the content data stream can be one that is encoded or compressed or both, and the adjusting step can include adjusting a level of encoding or compression or both depending upon a processing intensity level for the devices. Still further, the method can also include determining at the device at least one parameter related to a performance level for a network link used by the device to communicate through the network, and the adjusting step can depend upon the application level parameter and the network level parameter to adjust the content data stream. In addition, the network can be a wireless network; the delivering step can utilize a content server and a wireless access point to deliver the content data stream to the device; and the method can further include analyzing at the content server the application level parameter and determining at the content server a bit rate for the content data stream.

In another embodiment, the present invention is a managed network content delivery system including a content server coupled to a network and configured to deliver a content data stream and including a device coupled to the network and configured to receive the content data stream. The device can include a network interface processor and a feedback processor configured to communicate to the network interface processor at least one parameter related to a performance level for an application operating on the device to deliver the content to a user. And the network interface processor can be configured to communicate with the content server to adjust the content data stream in response to the parameter. Still further, the content server can be a media server computer located within a home, and a plurality of devices can be similarly configured to receive a plurality of content data streams from the media server computer. In addition, the media server computer can be coupled to a broadband internet connection.

In another embodiment, the present invention is an information handling system having application level content delivery control including a processor configured to run an application to deliver content to a user where the content is based upon a content data stream received through a network, a network interface processor, and a feedback processor configured to communicate to the network interface processor at least one parameter related to a performance level for the application. The network interface processor can be configured to communicate through the network with a content server to adjust the content data stream in response to the parameter. In addition, the network interface processor can be further configured to determine at least one parameter related to a performance level for a network link used to receive the content data stream.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a block diagram for an information handling system including an application level feedback processor for network bandwidth management according to the present invention.

FIG. 1B is a block diagram for a network processor and a feedback processor according to the present invention.

FIG. 2 is a block diagram for a network environment including a content delivery server and end devices that utilize application level feedback and control to manage network content delivery and bandwidth according to the present invention.

FIG. 3 is a block diagram for an home environment including a media server configured to deliver multi-media content to a variety of devices and to manage content delivery based upon application level feedback from these devices.

FIG. 4 is a block diagram for compression level control using application feedback processing according to the present invention.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention provides systems and methods for methods for managing network content delivery using client application workload patterns. More particularly, the present invention provides a solution for managing network content delivery and bandwidth in a home environment or a small or medium business (SMB) environment where network bandwidth is often not a significant constraint but processing power for end-user devices is a significant constraint with respect to the quality of service (QoS) for the delivered content. In such environments, processing power of the end device may create a bottleneck in delivering content with an adequate QoS.

As recognized by the present invention and contrary to prior solutions, in this scenario, it might be advisable to use up some amount of network bandwidth to reduce the processing requirements for the end device. For example, for compressed video streams, rather than require the end device to decode and decompress the video stream, a media server can perform these processing functions and then distribute decoded and uncompressed data through the network to the end device. Although this decoded and uncompressed data will take up more network bandwidth than the compressed video stream, the QoS of the end device is significantly improved. Thus, as recognized by the present invention, a decision can be made based upon the application level performance of the end device in conjunction with network bandwidth management to determine if the end device QoS can be improved by reducing the end device processing requirements while increasing network bandwidth usage by that end device.

The present invention, therefore, solves the QoS problem in end devices with limited processing power by building intelligence into the network that comprehends the end device's computing abilities in addition to the QoS requirements of the wireless links for the particular application. Existing wireless networks support data rate adaptability depending on the link conditions. For example, with certain wireless communication protocols, such as 802.11(g), a 54 Mbps data rate can be achieved when a device is in close range to the wireless access point (WAP) but this rate can drop down to 1 Mbps under adverse link conditions. The present invention provides similar intelligence at the application layer so that the encoding of the multimedia stream is able to adapt to the processing abilities of the end device. In this way, QoS of the delivered content can be improved by having the content server perform more of the processing required to deliver the content at the expense of using more network bandwidth to deliver the content data stream to the end device.

One implementation of this application level feedback mechanism according to the present invention utilizes changes to the wireless device drivers in the end device and in the system delivering the content so that they are able to communicate this application level information to each other. A relative simple implementation for this mechanism is to specify levels of processing intensity at the end device. For example, three levels could be defined: minimal work load, average work load and excessive work load. These levels of processing intensity can be calculated in real-time by processor performance counters and policy managers, as well as through inputs about application power states, within existing microprocessors and related systems. These inputs can then be used to provide feedback to the network processor or the network driver to determine optimal data stream and network link parameters.

For many applications running on the end device, the minimal and average work load conditions would likely require no action on the part of the encoding device, such as a media center personal computer (PC) in a home environment, in order to maintain an adequate QoS at the end device. However, in the excessive work load scenario, the encoding device will likely have to decide if the network is capable of supporting a higher bit rate stream. Then, if possible, the encoding device will switch to a different compression scheme to allow the end device to utilize less processing power and thereby improve the QoS of the content delivery at the end device.

The thresholds for switching content data stream parameters, such as switching between compression schemes, can depend upon end device system utilization, network conditions, QoS requirements, and/or any other desired parameter. For example, in a home environment there will likely be a smaller number of clients as compared to a small or medium business (SMB) environment. Therefore, it will often be desirable to use more bandwidth in the home environment when there are fewer clients contending for the wireless bandwidth. In addition, as next generation wireless networks, such as 802.11(n) and ultra-wideband (UWB) begin scaling wireless network bandwidths towards 1 Gbps and beyond, network bandwidth will become more available for use in increasing the bit rate of the delivered content (e.g., less compression) thereby reducing the processing requirements of end devices. Furthermore, as the proliferation of smart mobile wireless devices in the digital home increases and as VoWLAN (voice over wide local area network) handsets and other rich multimedia smart devices become common in the SMB and corporate space, there will be an increased need to optimize bit rates for content data streams, related bandwidth utilization and end-device performance to provide the best customer experience in a mixed mode digital network environment.

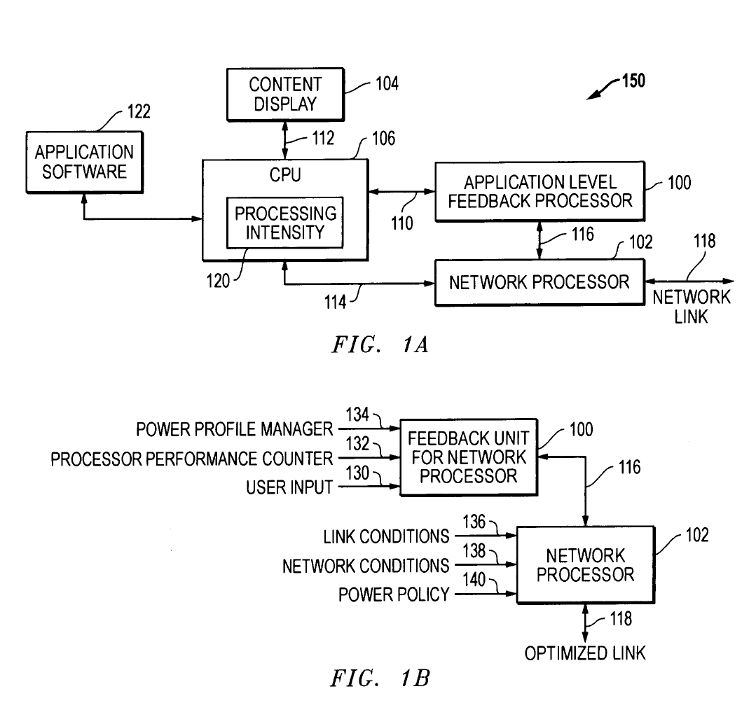

FIG. 1A is a block diagram for an information handling system 150 including an application level feedback processor 100 for network bandwidth management according to the present invention. As depicted, a central processing unit (CPU) 106 for the information handling system 150 is operating to run application software 122 and to display network-based content associated with the application software 122 on the content display 104 through communication link 112. The CPU 120 can also be operating to communicate information to and from an external network through network link 118 utilizing network processor 102. The CPU 120 and the network processor 102 can communicate through communication link 114. As depicted, the CPU 106 also includes a processing intensity block 120 that can report processor usage parameters to external devices or other system circuitry or devices. For example, the CPU 106 can report processor usage parameters to the application level feedback processor 100 through communication link 106.

FIG. 1B is a block diagram for a network processor 102 and a feedback processor 100 according to the present invention. The feedback unit 102 for the network processor 100 receives inputs that relate to the application level performance and workload of the system. As depicted, these inputs are power profile manager input 134, processor performance counter input 132, and user input 130. The network processor 102 receives feedback from the feedback unit 100 through communication link 116. The network processor 102 also receives inputs that relate to the condition of the network and the information handling system 150. As depicted, these inputs are network link conditions input 136, network conditions input 138, and power policy input 140. Utilizing these inputs and the application level feedback information, the network processor 102 can then work with the system delivering the content data stream to create an optimized data link for the network communication link 118 including adjusting data stream parameters and adjusting network link parameters based upon one or more application level parameters and one or more network level parameters.

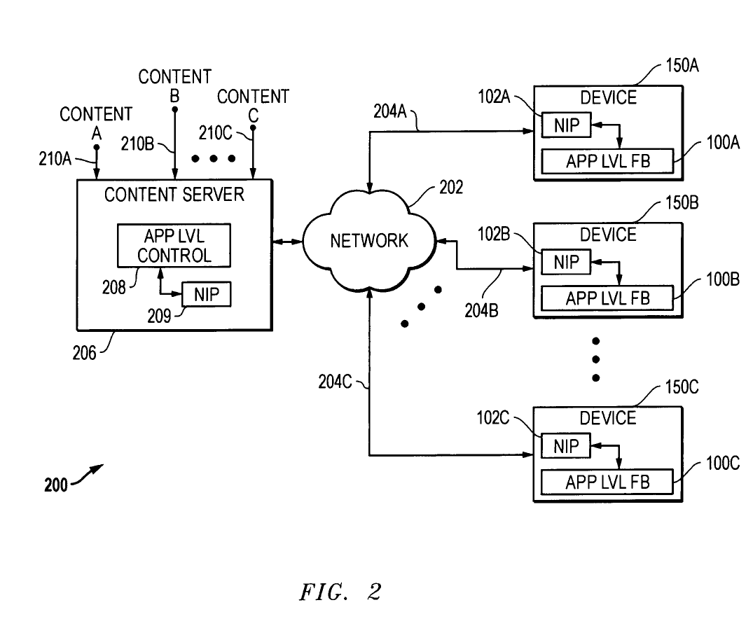

FIG. 2 is a block diagram for a network environment 200 including a content server 206 and end devices 150A, 150B . . . 150C that utilize application level feedback and control to manage network bandwidth and content data stream parameters according to the present invention. As depicted, a network 202 allows for communication between the content network server 206 and the end devices 150A, 150B . . . 150C. More specifically, the content server 206 operates to provide desired content to the devices 150A, 150B . . . 150C through a network and respective communication channels 204A, 204B . . . 204C to those devices. The content can be any desired content received through a network connection or from any other source that is managed and delivered by the content server 206. This content is depicted as CONTENT A 210A, CONTENT B 210B . . . CONTENT C 210C, and it is recognized that this content could be received from through the network 202, if desired.

According to the present invention, the devices 150A, 150B . . . 150C include network interface processors (NIPs) 102A, 102B . . . 102C communicating with application level feedback processors (APP LVL FB) 100A, 100B . . . 100C. In turn, the content server 206 includes a network interface processor (NIP) 209 communicating with an application level control (APP LVL CONTROL) block 206. As discussed above, the application level feedback processors 100A, 100B . . . 100C provide an application level indication of performance of the system and the quality of the content being delivered the user of the devices. The NIPs 102A, 102B . . . 102C communicate this information through the network to the NIP 209 of the content delivery server 206. The content delivery server 206 can then analyze this quality of service (QoS) information with the application level control block 208 to adjust the content so that the quality of the content delivery to the end user of the devices 150A, 150B . . . 150C is improved. The analysis of application level parameters can also be conducted by other systems within the networked environment. For example, a network router could perform the function of determining the network link data rate for a particular device and the parameters for the content data stream. In short, whether performed in the device, the network infrastructure, or the content server or a combination thereof, the content data stream is adjusted based upon the application level parameters generated at the device with respect to performance, processing intensity, QoS, or other desired aspects of how the content is being delivered to the end user.

Significantly, this application level focus of the present invention is in contrast with the network bandwidth focus of most network management solutions. Rather than trying to manage network bandwidth solely using network congestion determinations, the present invention can also manage network bandwidth usage based upon the application level performance of the devices 150A, 150B . . . 150C. Thus, decisions concerning compression, decoding, etc. for the content data streams, and thereby the bit rate for these content data streams, is determined based upon how well the end device can handle the incoming content stream at an application level. More traditional bandwidth allocation and management can then be provided, if desired, as an additional management layer used in conjunction with the application level management of the present invention.

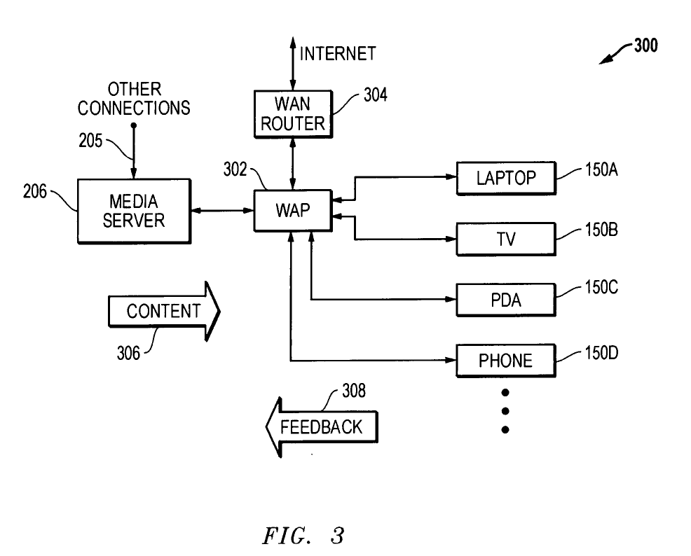

FIG. 3 is a block diagram for a home environment 300 including a media server 206 configured to deliver multi-media content 306 to a variety of devices 150A, 150B, 150C, 150D . . . and to manage content delivery based upon application level feedback 308 from these devices. As depicted, a wide area network (WAN) router 304 is connected to the Internet, for example, through a cable modem or DSL modem connection. A wireless access point (WAP) 302 is connected to the WAN router 304 to provide wireless access for home devices. A media server 206, such as a desktop computer running MICROSOFT Media Server software, provides a clearinghouse for content distribution within the home environment 300. In addition to content from the Internet, the media server 206 can also receive content from other connections 205 such as cable television, cable audio broadcasts, terrestrial television, cable audio broadcasts, satellite television, satellite audio broadcasts, or any other desired source. The media server 206 can then deliver this content 306 through WAP 302 to wireless connected devices, such as a personal laptop computer 150A, a television (TV) 150B, and personal digital assistant (PDA) 150C, a telephone (PHONE) 150D, etc. These devices could also be connected through wired networks, if desired. The devices 150A, 150B, 150C, 150D . . . then provide application level feedback 308 through the network to the media server 206. In this way, the media server 206 can adjust parameters associated with the content streams being provided to the devices based upon the application level feedback being received.

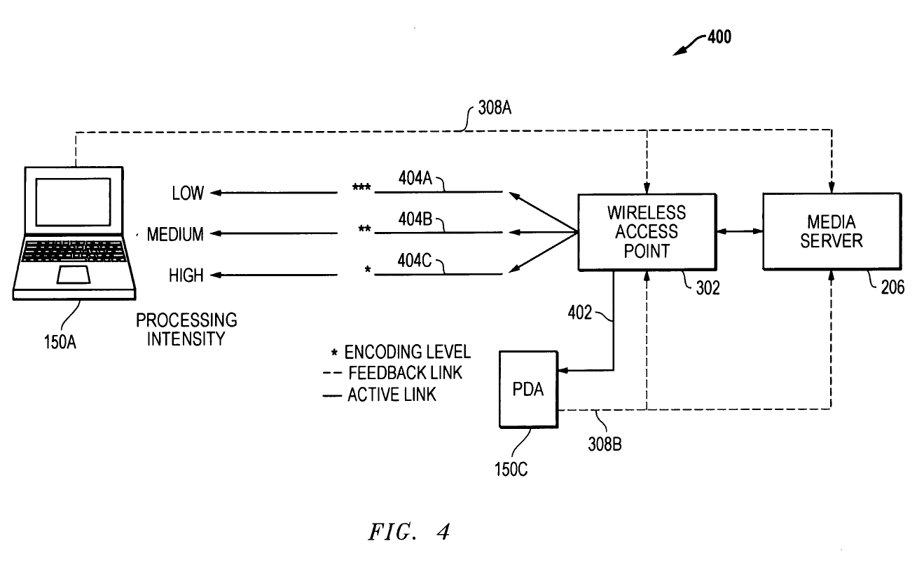

FIG. 4 is a block diagram for compression level control environment 400 using application feedback processing according to the present invention. A media server 206 is delivering content to a PDA 150C and a laptop computer 150A through a WAP 302. The content 402 to the PDA 150C could be information such as an Internet website. With respect to feedback 308B, the PDA 150C provides feedback to the WAP 302 concerning network link performance and provides feedback to the media server 206 concerning its application level performance and QoS. For the laptop 150A, the content 404 is assumed to be content that is encoded and/or compressed, such as an MPEG2 digital video stream. With respect to feedback 308A, the laptop 150A provides feedback to the WAP 302 concerning network link performance and provides feedback to the media server 206 concerning its application level performance and QoS.

As depicted, the application level parameter takes the form of a processing intensity level report using three levels: low intensity, medium intensity and high intensity. Based upon the processing intensity level reported to the media processor 206, the media server 206 then adjusts the level of encoding, as represented by the number of asterisks “*”. In particular, as depicted, for the low processing intensity level, the three asterisks “***” represents that a high level of encoding is utilized for the content data stream 404A being delivered by the media server 206 through the WAP 302. This high encoding level recognizes that the laptop 150A has the application level processing power to handle the decoding required for the content data stream without sacrificing the QoS for the delivered content. For the medium processing intensity level, the two asterisks “**” represents that a medium level of encoding is utilized for the content data stream 404B being delivered by the media server 206 through the WAP 302. This medium encoding level recognizes that the laptop 150A may not have the application level processing power to handle a high level of encoding without sacrificing the QoS for the delivered content. And for the high processing intensity level, the one asterisk “*” represents that a low level of encoding is utilized for the content data stream 404C being delivered by the media server 206 through the WAP 302. This low encoding level recognizes that the laptop 150A may not have the application level processing power to handle a high or medium level of encoding without sacrificing the QoS for the delivered content. It is noted that the feedback links are designated with dotted lines, and the active links are designated with solid lines. However, it is understood that all of these communications could be through packetized IP-based communications through the wireless network.

Thus, as described herein, in addition to wireless link analysis done by prior systems, the present invention also includes an analysis of application level performance in order to improve QoS of delivered content by adjusting the content data stream parameters. For example, the encoding and compression level of the data stream can be reduced when the application level intensity increases. Although this change to the data stream will take up more network bandwidth, it improves QoS of the delivered content at the end device. Unlike prior solutions, which focused only on the network bandwidth and link conditions, the present invention also considers application level conditions to adjust the content data stream being sent across the network data link rather then simply adjusting the network data link itself. As wireless network devices proliferate in the home and SMB environment and as wireless network bandwidths increase in these environments, the present invention will become even more advantageous in utilizing additional available bandwidth by increasing the bit rate of delivered content in order to reduce the processing requirements at the end device and to improve the QoS for the delivered content at the end device.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for managing network content delivery, comprising:
communicating a content data stream through a network to a device;
determining at the device at least one parameter related to a performance level for an application operating on the device to deliver the content to a user; and
adjusting the content data stream to thereby adjust an amount of processing required by the device depending upon the parameter.

2. The method of claim 1, wherein the communicating steps utilizes a wireless network.

3. The method of claim 2, wherein the communicating step comprises communicating a plurality of content data streams through the wireless network to a plurality of devices, wherein the determining step comprises determining at each device at least one parameter related to a performance level for an application operating on that device to deliver content to a user, and wherein the adjusting step comprises adjusting the content data stream for each device to thereby adjust an amount of processing required by the device depending upon the application level parameter for that device.

4. The method of claim 1, wherein the determining step comprises determining a processing intensity level for the device.

5. The method of claim 4, wherein at least three processing intensity levels are utilized.

6. The method of claim 4, wherein the communicating step comprising communicating a content data stream that is encoded or compressed or both, and wherein the adjusting step comprises adjusting a level of encoding or compression or both depending upon the processing intensity level.

7. The method of claim 6, wherein the adjusting step comprises reducing the level of encoding or compression to reduce processing required by the device in response to the processing intensity level being at a first level and increasing the level of encoding or compression to increase processing required by the device in response to the processing intensity level being at a second level.

8. The method of claim 7, wherein the first level and the second level are the same.

9. The method of claim 1, further comprising repeating the communicating, determining, and adjusting steps as the content is delivered by the device.

10. The method of claim 1, further comprising also determining at the device at least one parameter related to a performance level for a network link used by the device to communicate through the network, and wherein the adjusting step depends upon the application level parameter and the network level parameter to adjust the content data stream.

11. The method of claim 1, wherein the network comprises a wireless network, wherein the delivering step utilizes a content server and a wireless access point to deliver the content data stream to the device, and further comprising analyzing at the content server the application level parameter and determining at the content server a bit rate for the content data stream.

12. A managed network content delivery system, comprising:
a content server coupled to a network and configured to deliver a content data stream; and
a device coupled to the network and configured to receive the content data stream, the device comprising:
a network interface processor; and
a feedback processor configured to communicate to the network interface processor at least one parameter related to a performance level for an application operating on the device to deliver the content to a user;
wherein the network interface processor is configured to communicate with the content server to adjust the content data stream in response to the parameter.

13. The managed network content delivery system of claim 12, wherein the network comprises a wireless network.

14. The managed network content delivery system of claim 13, wherein the parameter comprises a processing intensity level for the device.

15. The managed network content delivery system of claim 13, wherein a bit rate for the content data stream is adjusted in response to the parameter.

16. The managed network content delivery system of claim 15, wherein an encoding level or a compression level or both for the content data stream is adjusted in response to the parameter.

17. The managed network content delivery system of claim 13, wherein the content server comprises a media server computer located within a home, and further comprising a plurality of devices configured to receive a plurality of content data streams from the media server computer, each additional device also comprising:
a network interface processor; and
a feedback processor configured to communicate to the network interface processor at least one parameter related to a performance level for the application operating on the device to deliver content to a user;
wherein the network interface processor is configured to communicate with the content server to adjust the content data stream in response to the parameter.

18. The managed network content delivery system of claim 17, wherein the media server computer is coupled to a broadband internet connection

19. A information handling system having application level content delivery control, comprising
a processor configured to run an application to deliver content to a user, the content being based upon a content data stream received through a network;
a network interface processor; and
a feedback processor configured to communicate to the network interface processor at least one parameter related to a performance level for the application;
wherein the network interface processor is configured to communicate through the network with a content server to adjust the content data stream in response to the parameter.

20. The device of claim 19, wherein the network interface processor is further configured to determine at least one parameter related to a performance level for a network link used to receive the content data stream.
